(19) United States
(12) Patent Application Publication
(10) Pub. No.: US 2012/0133850 A1
(43) Pub. Date: May 31, 2012

(54) DEVICE FOR GENERATING ENCRYPTED IMAGES VISIBLE ONLY THROUGH A POLARIZING FILTER AND PROCESS FOR MAKING THE DEVICE

(75) Inventors: Martin Eduardo Broen, Milano (IT); Emanuele Teobaldo, Castel Gandolfo (IT); Enrico Girotti, Cesena (IT); Giacomo Melani, Milano (IT)

(73) Assignee: LUXOTTICA S.R.L., I-32021 AGORDO (IT)

(21) Appl. No.: 13/133,806

(22) PCT Filed: Dec. 23, 2009
(86) PCT No.: PCT/IB09/55939

§ 371 Date: Jul. 11, 2011

(30) Foreign Application Priority Data
Dec. 23, 2008 (IT) BO2008A000772

(51) Int. Cl. G02F 1/13

(52) U.S. Cl. 349/1

(57) ABSTRACT

A device (1) for generating encrypted images which are only visible through a polarizing filter (5) oriented in a predetermined direction, comprises: a source (3) of digital information; an LCD screen (2) connected to said source (3) to form on its front face a matrix of chromatic filters which represents images; a polarizing layer (4) oriented in a predetermined direction and located behind a rear face of the LCD screen (2) to intercept a beam of light passing through the LCD screen (2) and oriented towards an observer of the front face.

### TECHNICAL FIELD

This invention relates to a device for generating encrypted images visible only through a polarizing filter and to a process for making the device.

In particular, the invention addresses the field of devices used for advertising or demonstration purposes and having optical properties such as to allow images or filmed sequences to be viewed only through polarizing filters such as, for example, polarized sunglass lenses.

### BACKGROUND ART

In this field, labels and cards are known which are used for demonstration purposes in the sale of glasses with polarized lenses and which comprise multi-layer structures consisting of a polarizing layer with a transparent sheet bearing an image applied to it.

Owing to the polarizing layer behind the sheet bearing the image, the image is visible only through glasses with polarized lenses.

These solutions have the drawback of allowing images to be viewed only in black and white or shades of grey.

Also, these solutions can be used to view only static images and not filmed sequences or complex images modifiable over time.

It should also be noted that an art form known as “polage” is used by American artist Austine Wood Comarow to create coloured images.

According to the polage technique, pieces of cellulose are cut and arranged in mosaic style to form a layer placed on a transparent surface. The rear face of the mosaic is irradiated with polarized light. A polarizing screen is rotated in front of the front face of the mosaic.

The effect obtained is that of a coloured image that changes over time according to the angle of rotation of the polarizing screen relative to the orientation of the polarized light.

The polage technique exploits the optical properties of cellulose, which is an optically active material.

Optically active materials are materials which, when crossed by a ray of polarized light, rotate the orientation of polarization of the light ray. The type of rotation depends on the nature and thickness of the specific material crossed by the ray. This optical property is also known as birefringence.

Polage, however, is a technique for creating images that change over time and is not concerned with devices that reproduce encrypted images (used for advertising purposes or of a promotional nature) which are visible only through polarizing screens.

Moreover, polage is an extremely complicated technique because the size of the cellulose pieces determines the resolution of the image obtained: the higher the resolution required for the image the smaller the pieces of cellulose must be cut.

Polage, therefore, which was developed as a form of art, would be inconvenient and unsuitable for adaptation to an industrial application.

Thus, no devices are known for viewing encrypted images or filmed sequences visible only through polarizing filters.

In effect, images and filmed sequences viewed with prior art viewing devices must be unencrypted, that is to say, the images and filmed sequences can be viewed without the aid of any special filters.

For example, one prior art solution for image viewing devices is embodied by LCD screens.

A liquid crystal or LCD (Liquid Crystal Display) screen is a thin, lightweight screen based on the optical properties of certain substances known as liquid crystals. In an LCD screen, a liquid is trapped between two vitreous panels provided with a very high number of electrical contacts which can be used to apply an electrical field to the liquid. Each electrical contact controls a small portion of the panel identifiable as a pixel (or subpixel for colour screens).

It should be noted that in the context of liquid crystal screens, plasma screens are also known. The latter differ from the LCD screens described above in that each pixel is physically separate from the pixels adjacent to it (in LCD screens other than plasma the pixels are not separate).

On the outside faces of the vitreous panels, there are two polarizing filters positioned on axes perpendicular to each other. The liquid crystals twist by 90 degrees the polarization of the light coming from one of the polarizers, allowing it to pass through the other.

Before the electric field is applied, the light can pass through the entire structure and, apart from the portion of light absorbed by the polarizers, the unit is transparent. When the electrical field is activated, the liquid molecules line up parallel with the electric field, thus limiting the rotation of the incoming light. When the crystals are completely aligned with the field, the light passes through and is polarized perpendicularly to the second polarizer and is thus stopped completely, causing the pixel to appear non-illuminated. By controlling liquid crystal twisting in each pixel, it is thus possible to control the amount of light that is allowed to pass. It should be noted, however, that this way, a faulty pixel will always appear illuminated. In actual fact, some types of panels work in the opposite way, that is to say, they are transparent when on and opaque when off, which means that a faulty pixel is always opaque.

Prior art systems for viewing images and filmed sequences are therefore optimized to render very high quality images at very low consumption levels; on the contrary, these systems are not designed to generate encrypted images or filmed sequences which are not visible without the aid of special filters.

### AIM OF THE INVENTION

This invention has for an aim to provide a device for generating encrypted images visible only through a polarizing filter and a process for making the device. Another aim of the invention is to provide a system for viewing encrypted images, in particular for advertising or demonstration purposes.

These aims are fully achieved by the device and process according to the invention as characterized in the appended claims.

### BRIEF DESCRIPTION OF THE DRAWINGS

These and other features of the invention will become more apparent from the following detailed description of a preferred, non-limiting example embodiment of it, with reference to the accompanying drawings, in which:

FIG. 1 schematically illustrates a device according to this invention in cross section;

FIG. 2 is a perspective view illustrating a first embodiment of the device of FIG. 1;

FIG. 3 is an exploded perspective view of the device of FIG. 2;

FIG. 4 schematically illustrates the device of FIG. 2 in cross section;

FIG. 5 is a perspective view illustrating a second embodiment of the device of FIG. 1;

FIG. 6 is an exploded perspective view of the device of FIG. 5;

FIG. 7 schematically illustrates the device of FIG. 5 in cross section;

FIG. 8 is a perspective view illustrating a third embodiment of the device of FIG. 1;

FIG. 9 is an exploded perspective view of the device of FIG. 8;

FIG. 10 schematically illustrates the device of FIG. 8 in cross section.

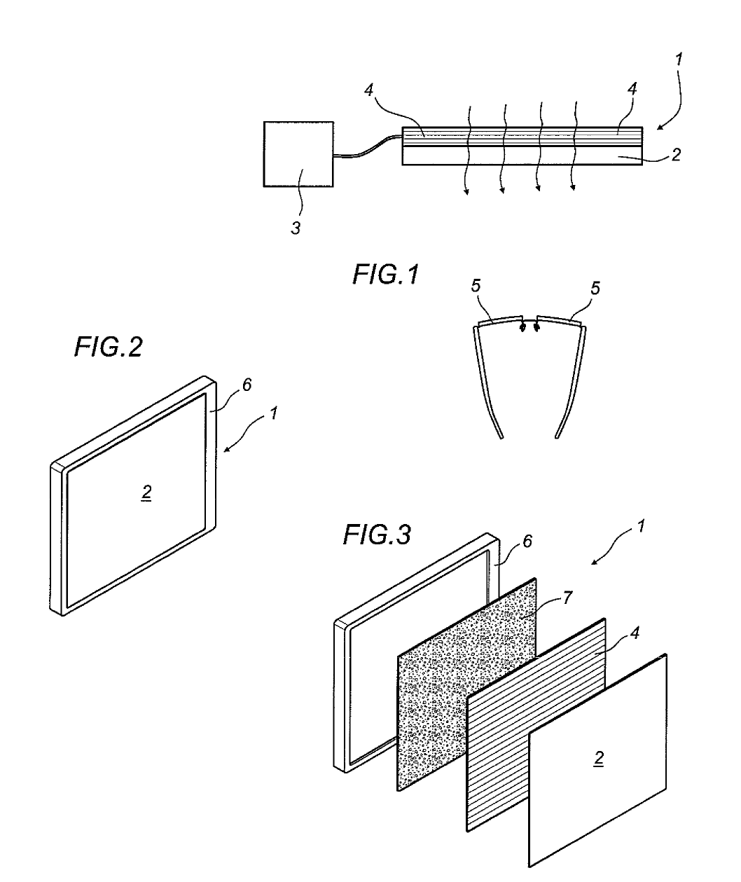

### DETAILED DESCRIPTION OF THE PREFERRED EMBODIMENTS OF THE INVENTION

The numeral 1 in the drawings denotes a device according to the invention.

The device 1 is a device for generating encrypted (i.e. normally hidden) images and/or filmed sequences, visible only through a polarizing filter; more specifically, it is a device for generating encrypted images and/or filmed sequences, visible only through a polarizing filter oriented in a predetermined direction.

In particular, the device 1 is a device for generating encrypted images and/or filmed sequences with an advertising content used for demonstration or promotional purposes.

The device 1 comprises an LCD (that is, liquid crystal) screen 2 or other equivalent screen (for example, plasma) of per se known type.

The device 1 also comprises a source 3 of digital information; in particular, the source 3 (consisting, for example, of an electronic card) is adapted to provide a digital output signal designed to drive the screen 2 for generating (that is, forming) on a front face of the screen 2 an image corresponding to said information (according to a method well known in the field of LCD screen technology). The LCD screen is provided with its own power supply or is connected to an external power supply according to a method well known in the field of LCD screen technology.

More specifically, the LCD screen 2 is connected to the source 3 to form on its front face a matrix of chromatic filters which represents the images.

The device 1 also comprises a polarizing layer 4.

The polarizing layer 4 is oriented in a predetermined direction, that is to say, it is adapted to impart to a ray of light going through it a polarization oriented in predetermined manner.

The polarizing layer 4 is located behind a rear face of the LCD screen to intercept a ray of light passing through the LCD screen 2 and oriented towards a person observing the front face of the LCD screen 2.

The polarizing layer 4 and the LCD screen 2 lie in parallel planes.

Therefore, according to the invention, a beam of white light passing through the polarizing layer 4 and the LCD screen 2 generates on the front face of the LCD screen encrypted images (preferably coloured images), that is to say, images not visible to the person observing the front face of the screen 2 without interposed filters.

That is because the effect of the LCD screen 2 is that of rotating the polarization of the rays directed outwards from the screen 2 in a different way according to the zone of the screen 2 affected by those rays.

This variation in the orientation of the polarization is not, however, perceived by the human eye.

If a polarizing filter 5 oriented at right angles to the polarizing layer 4 of the device 1 is placed between the front face of the LCD screen 2 and the observation point, the image defined by the information transmitted by the source 3 is displayed on the front face of the screen 2, since the polarizing filter 5 selectively prevents transmission of (that is, it absorbs) the rays whose polarization orientation has not been rotated.

This invention therefore also provides a system for viewing encrypted images.

The system comprises the device 1 (made according to the foregoing description) and the polarizing filter 5.

According to the invention, the polarizing filter 5 is disengaged from the device 1 so that it can be placed at any point for observing the device 1 which is spaced from it.

Preferably, the polarizing filter 5 consists of polarized glass lenses.

Preferably, according to the invention, the polarizing layer 4 of the device 1 is oriented horizontally, while the glasses comprise lenses with vertical polarization, the lenses constituting the polarizing filter 5 (thus, the polarizing filter 5 is preferably oriented vertically).

More specifically, this invention contemplates four embodiments for the device 1.

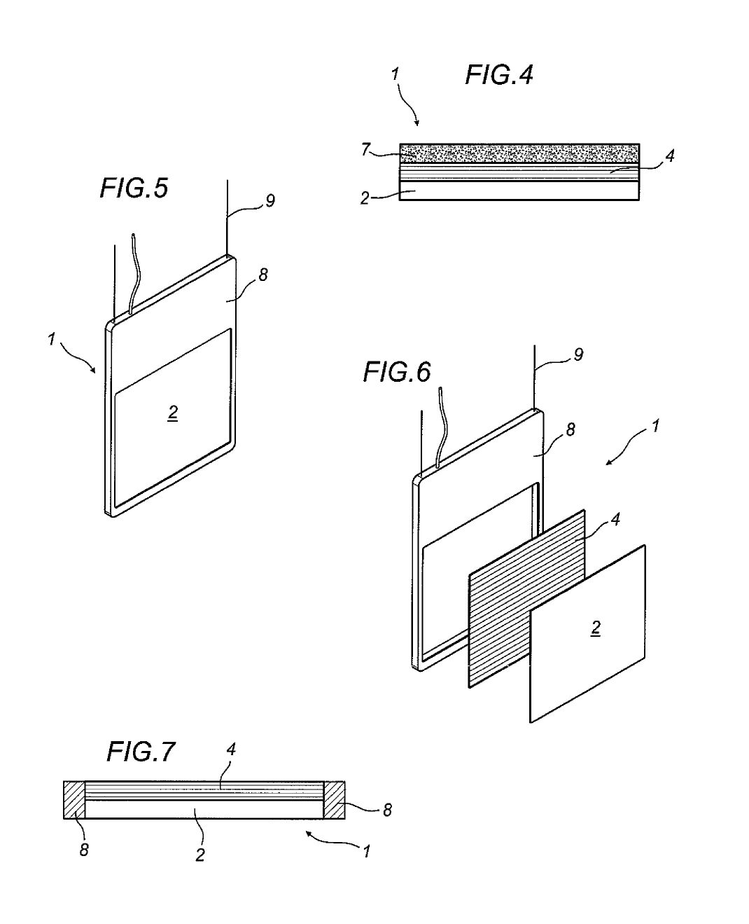

A first embodiment of the device 1 (illustrated in FIGS. 2 to 4) contemplates the following.

The polarizing layer 4 is preferably in contact with the rear face of the LCD screen 2.

The device 1 also comprises a box-shaped casing 6 forming an opening which houses the assembly consisting of the polarizing layer 4 and the LCD screen 2. The box-shaped casing 6 contains the source 3.

The device 1 also comprises an emitter 7 of a beam of rays of white light located behind the polarizing layer 4 and oriented in such a way that the rays pass through first the polarizing layer 4 and then the LCD screen 2.

The emitter 7, constituting a source of white light, is contained inside the box-shaped casing 6. Thus, the emitter 7 is located behind the polarizing layer 4 and is oriented towards the front face of the LCD screen 2.

Thus, the first embodiment of the device 1 advantageously constitutes a monitor showing encrypted images visible only through special polarizing filters.

A second embodiment of the device 1 (illustrated in FIGS. 5 to 7) contemplates the following.

The polarizing layer 4 is preferably in contact with the rear face of the LCD screen 2.

The device 1 comprises a frame 8 located outside an edge (that is, the perimetric lateral edge) of the multi-layer system consisting of the LCD screen 2 and the polarizing layer 4.

More specifically, the frame 8 is connected to the lateral edge of the multi-layer system consisting of the LCD screen 2 and the polarizing layer 4 and constitutes a mounting for it.

The frame 8 is preferably a box-shaped casing for containing the source 3.

The device 1 comprises anchoring means 9 fixed to the frame 8 for hanging the device (for example to a ceiling). In the example illustrated, the anchoring means 9 comprise wires; alternatively the anchoring means 9 comprise articulated arms allowing the frame 8 and the LCD screen 2 contained inside it to be moved to a desired position.

It should be noted that a novel aspect of the second embodiment of the device 1 is that it does not have the emitter 7.

Advantageously, that makes it possible to view on a transparent surface images or writing or other information (for advertising purposes for example) appearing over whatever is behind the device 1, visible through the transparent surface; the writing and information are visible only when the viewer wears the glasses constituting the polarizing filter 5, whereas without the filter 5, the part of the device 1 enclosed by the frame 8 is completely transparent.

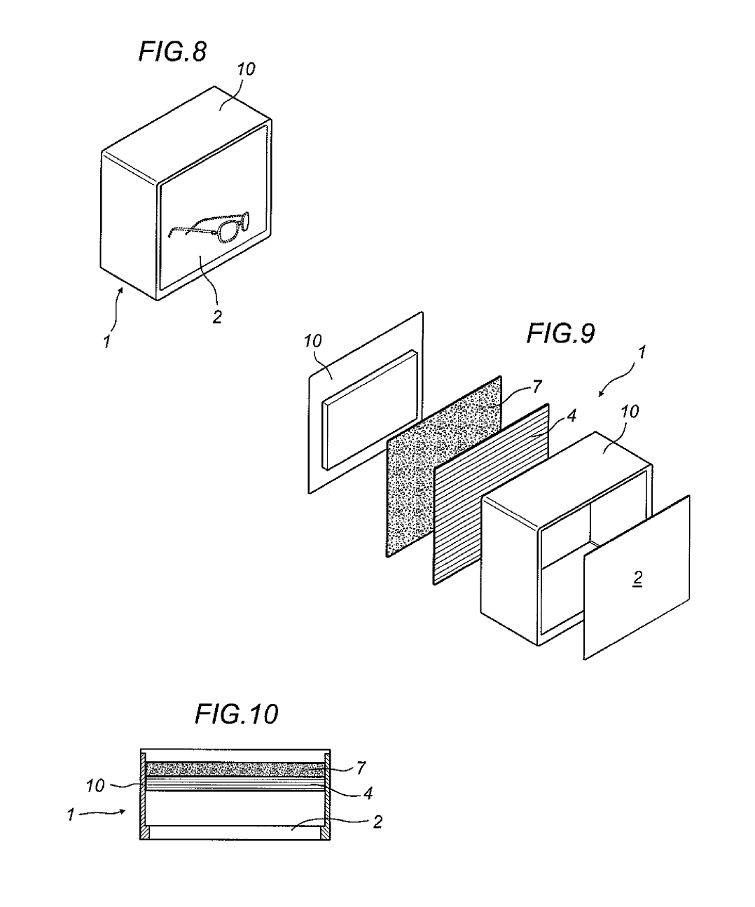

A third embodiment of the device 1 (illustrated in FIGS. 8 to 10) contemplates the following.

The polarizing layer 4 is located at a predetermined distance from the LCD screen 2 facing it, forming a space interposed between the polarizing layer 4 and the LCD screen 2; according to the invention, an object can be positioned inside this space.

The device 1 also comprises the emitter 7 described in connection with the first embodiment. The emitter 7 is positioned behind, and preferably in contact with, the polarizing layer 4.

The device 1 comprises a box 10 (that is, a box-shaped casing) containing the emitter 7, the polarizing layer 4 and the LCD screen 2. The box 10 forms, inside it, the space for positioning the object.

Advantageously, that makes it possible to view on an object images or writing or other descriptive information (for advertising purposes for example) appearing on the object; this descriptive writing and information become visible only when the viewer wears the glasses constituting the polarizing filter 5, whereas the object itself is always visible.

A fourth embodiment of the device 1 contemplates the following.

The device 1, like that of the first embodiment, comprises the emitter 7 and the box-shaped casing 6 containing the information source 3.

In this case, the source 3 of information comprises a module adapted to make available a digital signal representing a filmed sequence (comprising the images).

More specifically, the information source 3 comprises a device (made according to technology that is per se known) for viewing filmed sequences.

In all the embodiments described above, the polarizing layer 4 is oriented in such a way that the rays of light passing through it have a horizontally oriented polarization, parallel with the ground.

Advantageously, that allows the images to be viewed only through glasses with polarized lenses, that is having a vertical polarization.

This invention also provides a process for generating encrypted images which are only visible through a polarizing filter 5 oriented in a predetermined direction.

The process comprises the following steps:
preparing a source 3 of digital information;
preparing the LCD screen 2 designed to form on its front face a matrix of chromatic filters which represents images;
positioning the polarizing layer 4 behind a rear face of the LCD screen 2 to intercept a ray of light passing through the LCD screen oriented towards a person observing the front face, the polarizing layer being oriented in a predetermined direction (preferably horizontal);
feeding the LCD screen 2 with a control signal generated by the source 3.

This invention offers the following advantages.

The invention provides a simple and inexpensive system for generating encrypted images and/or filmed sequences, that is, invisible if an interposed polarizing filter 5 with predetermined orientation is not used.

This is especially useful for commercially promoting and advertising special glasses equipped with polarized lenses having predetermined orientation; in effect, the system makes it possible to generate images and filmed sequences which are visible only when wearing glasses of this type.

The invention lends itself to numerous applications, such as a monitor showing encrypted images (according to the first embodiment); a transparent multi-layer screen, able to be positioned anywhere and making it possible to view encrypted images superimposed over whatever is placed behind the screen (according to the second embodiment); a box, or display case, for exhibiting objects to be promoted, where encrypted writing and images of any kind can be superimposed over the objects and are visible only if the special lenses are worn; a device for viewing encrypted filmed sequences visible only if the special lenses are worn.

1. A device (1) for generating encrypted images which are only visible through a polarizing filter (5) oriented in a predetermined direction, comprising:
a source (3) of digital information;
an LCD screen (2) connected to said source (3) to form on its front face a matrix of chromatic filters which represents images;
a polarizing layer (4) oriented in a predetermined direction and located behind a rear face of the LCD screen (2) to intercept a ray of light passing through the LCD screen (2) and oriented towards an observer of the front face.

2. The device according to claim 1, wherein the polarizing layer (4) is in contact with the rear face of the LCD screen (2).

3. The device according to claim 2, comprising:
a frame (8) located outside an edge of the multi-layer system consisting of the LCD screen (2) and the polarizing layer (4) and connected there;
anchoring means (9) fixed to the frame for hanging the device.

4. The device according to claim 1, comprising an emitter (7) of a beam of rays of white light located behind the polarizing layer (4) and oriented in such a way that the rays pass through first the polarizing layer (4) and then the LCD screen (2).

5. The device according to claim 4, wherein the polarizing layer (4) is located at a predetermined distance from the LCD screen (2), forming a space interposed between the polarizing layer (4) and the LCD screen (2) in which an object can be positioned.

6. The device according to claim 5, comprising a box (10) containing the emitter (7), the polarizing layer (4) and the LCD screen (2), the box (10) forming, inside it, said space for positioning the object.

7. The device according to claim 4, wherein the source (3) of information comprises a module set up to make available a digital signal representing a filmed sequence comprising said images.

8. The device according to any of the foregoing claims, wherein the polarizing layer (4) is oriented in such a way that the rays of light passing through it have a horizontally oriented polarization, parallel with the ground.

9. A process for generating encrypted images which are only visible through a polarizing filter (5) oriented in a predetermined direction, comprising the following steps:
preparing a source (3) of digital information;
preparing an LCD screen (2) designed to form on its front face a matrix of chromatic filters which represents images;
positioning a polarizing layer (4) behind a rear face of the LCD screen (2) to intercept a ray of light passing through the LCD screen (2) oriented towards an observer of the front face, the polarizing layer (4) being oriented in a predetermined direction;
feeding the LCD screen (2) with a control signal generated by the source (3).

10. A system for viewing normally hidden images, comprising:
a device (1) according to any of the claims from 1 to 8;
a polarizing filter (5) oriented in a direction perpendicular to the direction of orientation of the device (1) polarizing layer (4) and disengaged from the device (1) so that it can be placed at a point for observing the device (1) which is distanced from it.
